(19) United States
(12) Patent Application Publication
(10) Pub. No.: US 2016/0277204 A1
(43) Pub. Date: Sep. 22, 2016

(54) METHOD AND APPARATUS FOR CONTROLLING SMART HOME SYSTEM

(71) Applicant: SAMSUNG ELECTRONICS CO., LTD., Suwon-si Gyeonggi-do (KR)

(72) Inventor: Man-Seok KANG, Gyeonggi-do (KR)

(21) Appl. No.: 15/034,414

(22) PCT Filed: Sep. 19, 2014
(86) PCT No.: PCT/KR2014/008721

§ 371 Date: May 4, 2016

(30) Foreign Application Priority Data
Nov. 4, 2013 (KR) 10-2013-0133060

(51) Int. Cl. H04L 12/28

(52) U.S. Cl. CPC H04L 12/2803; H04L 12/282; H04L 12/2809; H04L 12/2816

(57) ABSTRACT

The present disclosure relates to a sensor network, Machine Type Communication (MTC), Machine-to-Machine (M2M) communication, and Internet of Things technology. The present disclosure may be applied to intelligent services based on the above technologies, such as smart home, smart building, smart city, smart car, connected car, health care, digital education, smart retail, security and safety services. The present disclosure relates to a method and an apparatus for controlling a main device and sub device in a smart home system and an electronic device thereof. The method controls the main device and sub device by sensing a main device; sensing a sub device associated with the main device; storing information of the main device; storing information of the main device and information of the sub device associated with each other; receiving an instruction associated with the main device; and controlling the main device or the sub device based on the instruction.

### PRIORITY

This application is a U.S. National Phase application of PCT/KR2014/008721, filed on Sep. 19, 2014, claiming priority to Application No. 10-2013-0133060 filed with the Korean Intellectual Property Office on Nov. 4, 2013, the entire content of each of which is incorporated herein by reference.

### TECHNICAL FIELD

The present invention relates to an electronic device and, more particularly, to a method and an apparatus for controlling a main device and a sub device in a smart home system.

### BACKGROUND

The Internet, which is a human centered connectivity network where humans generate and consume information, is now evolving to the Internet of Things (IoT) where distributed entities, such as things, exchange and process information without human intervention. The Internet of Everything (IoE), which is a combination of the IoT technology and the Big Data processing technology through connection with a cloud server, has emerged. As technology elements, such as “sensing technology”, “wired/wireless communication and network infrastructure”, “service interface technology”, and “Security technology” have been demanded for IoT implementation, a sensor network, a Machine-to-Machine (M2M) communication, Machine Type Communication (MTC), and so forth have been recently researched.

Such an IoT environment may provide intelligent Internet technology services that create a new value to human life by collecting and analyzing data generated among connected things. IoT may be applied to a variety of fields including smart home, smart building, smart city, smart car or connected cars, smart grid, health care, smart appliances and advanced medical services through convergence and combination between existing Information Technology (IT) and various industrial applications.

Development of Internet Protocol version 6 (IPv6) has enables a unique IP to be assigned to each object. The assignment of a unique IP to each object has enabled each object to access Internet network and to transmit and receive data. Therefore, as an object Internet (internet of things) becomes possible, a study on the smart home system for effectively utilizing an automatic device has actively been progressed. The smart home system refers to a system for registering a plurality of devices to one electronic device and efficiently and intuitively controlling the plurality of registered devices. For example, a user of the smart home system does not directly control a TV, and the TV transmits a control signal to the registered electronic device so that the TV can be controlled.

However, when an operation of the device is to be controlled in the smart home system, the user should select a device, which allows the operation to be controlled, in a device list including a plurality of devices which can be controlled. Further, when a power of the corresponding device is to be controlled, the user should input a command by recognizing and selecting a plug module connected to the corresponding device. A series of processes as described above may make users, who are unused to operate the electronic device, feel uncomfortable.

Therefore, a method of simply controlling and managing the plurality of devices registered to the electronic device though a simple process in the smart home system is required to be provided.

### SUMMARY

Therefore, an embodiment of the present invention provides a method and an apparatus for controlling a main device and a sub device in an electronic device.

Another embodiment of the present invention provides a method and an apparatus for distinguishing a main device and a sub device in an electronic device.

Another embodiment of the present invention provides a method and an apparatus for correlating and storing information of a main device and information of a sub device in an electronic device.

Another embodiment of the present invention provides a method and an apparatus for determining a device to be a target of a control command received from a user equipment in an electronic device and controlling a target device based on a control command.

Another embodiment of the present invention provides a method and an apparatus for providing information of a main device and information of a sub device correlated to the main device, together.

In accordance with an aspect of the present invention, there is provided a method of a smart home gateway for controlling a smart home system. The method includes: sensing at least one main device; sensing at least one sub device correlated to the sensed main device; correlating and storing information of the main device and information of the sub device; receiving a command correlated to at least one device of the main device and a sub device correlated to the main device; and controlling at least one device of the main device and the sub device on the basis of the command.

In accordance with another aspect of the present invention, there is provided a smart home gateway apparatus for controlling a smart home system. The apparatus includes: a device list management unit that senses at least one main device, senses at least one sub device correlated to the sensed main device, and then correlates and stores information of the main device and information of the sub device; and a device operation control unit that receives a command correlated to at least one of the main device and a sub device correlated to the main device, and controls at least one device of the main device and the sub device on the basis of the command.

In accordance with another aspect of the present invention, there is provided a method of a user equipment for controlling a smart home system. The method includes: executing an application for controlling at least one device; displaying a device list indicating at least one main device registered in an electronic device acting as a home gateway; selecting one main device in the device list; and displaying information of the selected main device and information of at least one sub device correlated to the main device.

In accordance with another aspect of the present invention, there is provided a user equipment for controlling a smart home system. The user equipment includes: a display unit that, when an application for controlling at least one device is executed, displays a device list indicating at least one main device registered in an electronic device acting as a home gateway, and displays information of a main device selected by a user in the device list and information of at least one sub device correlated to the main device.

### BRIEF DESCRIPTION OF THE DRAWINGS

FIG. 1 illustrates a configuration of a system for controlling a main device and a sub device through a communication module in an electronic device according to an embodiment of the present invention.

FIG. 2 is a block diagram illustrating a configuration of an electronic device for controlling the main device and the sub device through the communication module according to an embodiment of the present invention.

FIG. 3A illustrates an example of correlating and managing information of the main device and information of the sub device according to an embodiment of the present invention.

FIG. 3B illustrates an example of correlating and managing information of the main device and the sub device according to another embodiment of the present invention.

FIGS. 4A and 4B illustrate a configuration of a control command received from a user equipment according to an embodiment of the present invention.

FIG. 5A illustrates a procedure of correlating and controlling the main device and the sub device in the electronic device according to an embodiment of the present invention.

FIG. 5B illustrates a means of correlating and controlling the main device and the sub device in the electronic device according to an embodiment of the present invention.

FIG. 6 illustrates a procedure of determining a device sensed in the electronic device as the main device or the sub device according to an embodiment of the present invention.

FIG. 7 illustrates a procedure of processing a control command received from the user equipment in the electronic device according to an embodiment of the present invention.

FIGS. 8 and 9 illustrate a User Interface (UI) for controlling the main device and the sub device in the user equipment according to an embodiment of the present invention.

### DETAILED DESCRIPTION

Hereinafter, preferable embodiments of the present invention will be described with reference to the accompanying drawings. Further, in the following description of the present invention, a detailed description of known functions or configurations incorporated herein will be omitted when it may make the subject matter of the present invention rather unclear. The terms which will be described below are terms defined in consideration of the functions in the present invention, and may be different according to users, intentions of the users, or customs. Accordingly, the terms should be defined based on the contents over the whole present specification.

Hereinafter, a method of sensing at least one device, distinguishing the sensed device as a main device or a sub device, grouping the main device and the sub device, and then controlling the main device and the sub device for each group, in an electronic device. The electronic device refers to a smart home gateway for controlling at least one home device registered in a smart home system.

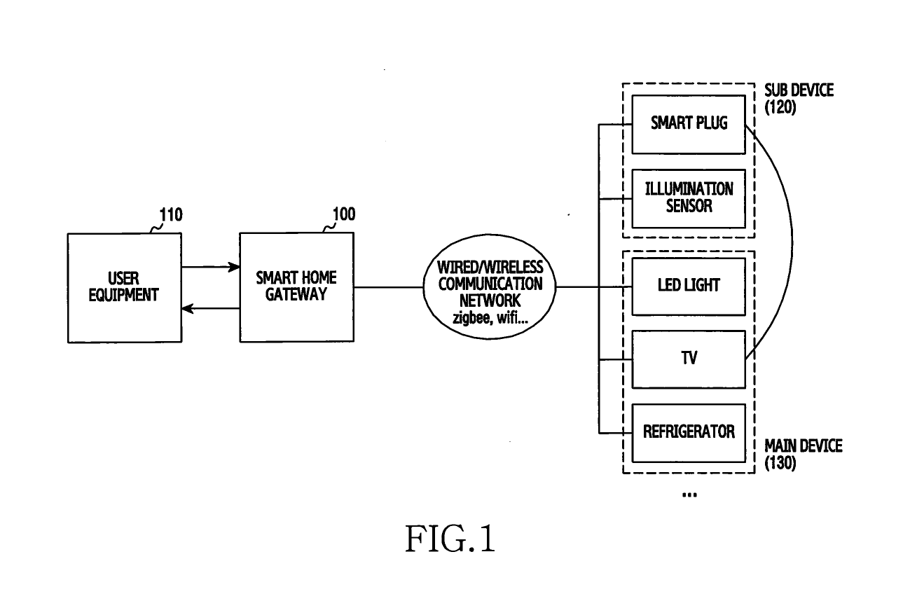

FIG. 1 illustrates a configuration of a system for controlling a main device and a sub device through a communication module in an electronic device according to an embodiment of the present invention.

Referring to FIG. 1, a user equipment 110 may control at least one home device through a smart home gateway 100. In this event, the user device 110 refers to a portable device such as a smart phone and a tablet PC. Further, the smart home gateway 100 corresponds to a device for controlling at least one home device through a wired/wireless communication network by receiving a control command from the user equipment 110 and analyzing the received control command, and refers to an electronic device described below.

First, the electronic device may sense at least one home device (e.g., a smart plug, an illumination sensor, LED lighting, a TV refrigerator, or the like) through the wired/wireless communication network such as ZigBee and Wi-Fi, and determine the sensed home device as a main device 130 or a sub device 120. Further, the electronic device may identify a correlation between the main device 130 and the sub device 120, and correlate and store information of the main device 130 and information of the sub device 120 which are correlated with each other. For example, the electronic device may identify that a TV which is the main device 130 is connected to a smart plug which is the sub device 120, and correlate and store the information of the TV and information of the smart plug.

Then, when a control command has been received from the user equipment 110, the electronic device may analyze the received control command, identify whether the corresponding command is a command for the main device 130 or a command for the sub device 120 correlated to the main device 130, and control the main device 130 and the sub device 120. In this event, the received control command may include Identification (ID) information of the main device 130. The information of the main device 130 may include ID information of the sub device 120 correlated to the main device 130. Therefore, the electronic device may determine which main device 130 the corresponding control command correlates, based on the ID information of the main device 130 included in the control command, and identify whether the control command is a command for the main device 130 or a command for the sub device 120 based on operation information included in the control command.

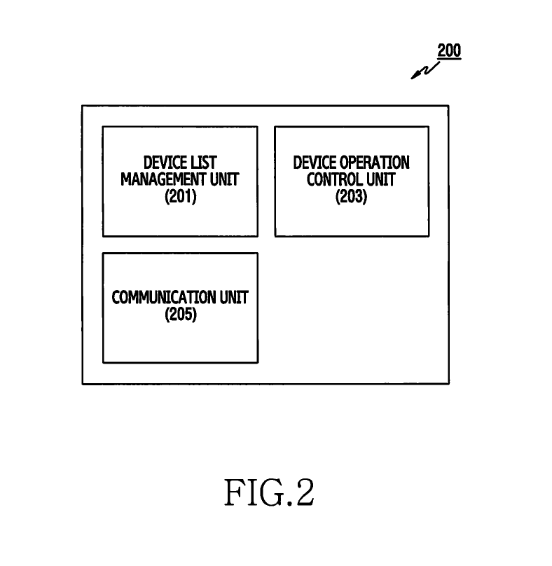

FIG. 2 is a block diagram illustrating a configuration of an electronic device for controlling the main device and the sub device through the communication module according to an embodiment of the present invention.

Referring to FIG. 2, an electronic device 200 includes a device list management unit 201, a device operation control unit 203, and a communication unit 205.

The device list management unit 201 may sense at least one device through a communication module and perform a connection with the sensed device. That is, the device list management unit 201 may sense at least one device including the communication module or an external smart home server through a wired/wireless communication module, and perform a connection with the sensed device or the external smart home server.

Further, the device list management unit 201 may determine the sensed device as the main device or the sub device. That is, when information on the corresponding device has been received from the sensed device, the device list management unit 201 may determine the sensed device as the main device or the sub device on the basis of the received information. For example, when the information on the corresponding device has been received from the sensed device, the device list management unit 201 may identify class information of the sensed device from the received information and determine the sensed device as the main device or the sub device on the basis of the identified class information. For another example, when information (e.g., a device type or ID) on the corresponding device has been received by the sensed device, the device list management unit 201 may compare previously stored database and the received information to determine the sensed device as the main device or the sub device. For example, the database may store “0x11: a microwave, 0x12: a cooktop, 0x13: a refrigerator, 0x14: a coffee pot, 0x15: an electric cooker, 0x16: a dishwasher, 0x17: a washer, and 0x18: a dryer” as IDs and type information of the main devices, and may store “0x90: a smart plug and 0x91: an illumination sensor” as IDs and type information of the sub devices. In addition, the database may store “0x00: unknown device and 0xFE: device distinction error” values. When 0x00 or 0xFF values have been received, the device list management unit 201 may request a user for a configuration of whether the device is the main device or the sub device.

In addition, the device list management unit 201 may receive a request for information of the device which can be controlled by the electronic device 200, and transmit the corresponding information to a user equipment. For example, when a request for information on a main device or a sub device which can be controlled by the electronic device 200 has been received from the user equipment, the device list management unit 201 may search corresponding information from a pre-stored database and transmit the searched information to the user equipment. For another example, when a request for information on a main device or a sub device which can be controlled by the electronic device 200 has been received from the user equipment, the device list management unit 201 may receive the corresponding information from the main device or the sub device and transmit the received information to the user equipment. In this event, information on the main device may include information on the sub device. Further, the information on the main device may include information on the main device and information on the sub device, and may include control commands for the main device and the sub device. Further, both the control commands for the main device and the sub device may be configured by a control command which can be performed in the main device.

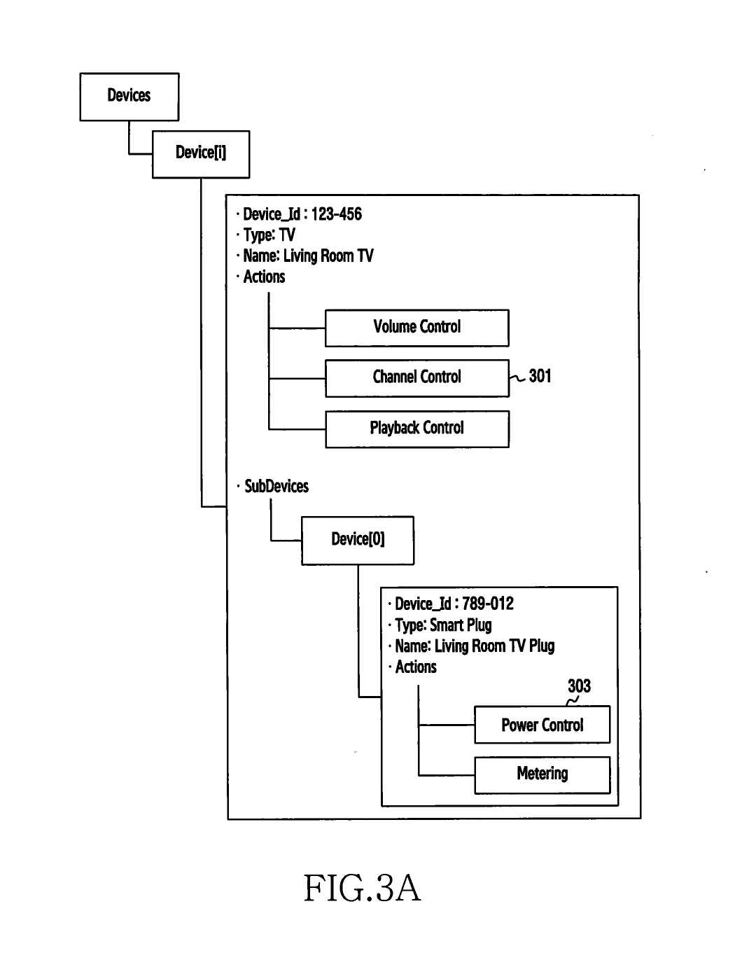

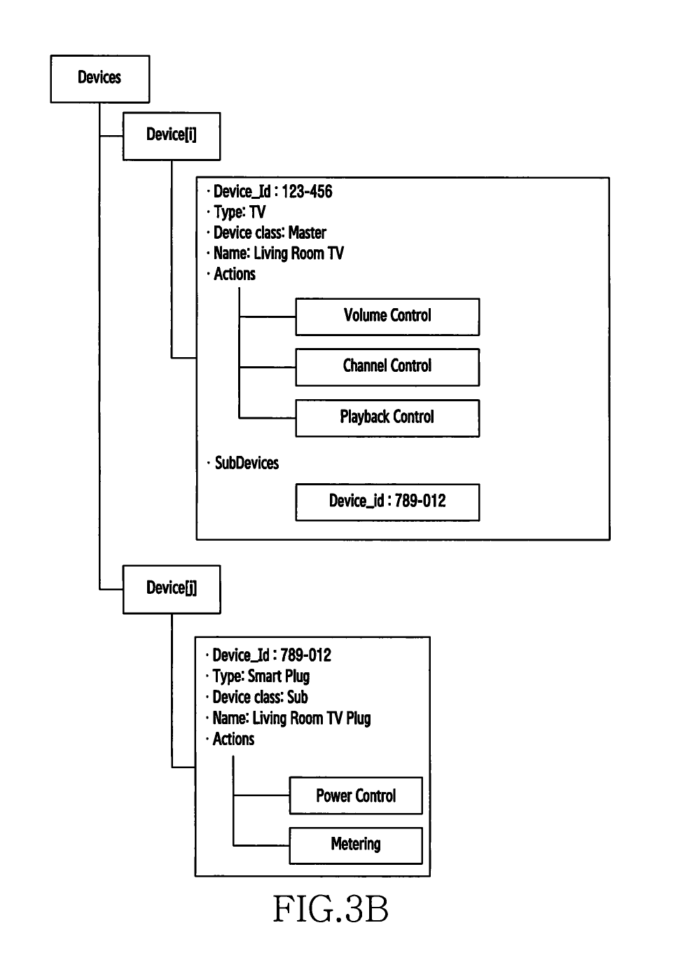

Also, the device list management unit 201 may identify a correlation between the main device and the sub device and store and manage, in a correlated manner, information of the main device and the sub device correlated each other. When the sensed device is the main device, the device list management unit 201 may identify whether a sub device correlated to the sensed main device exists. Further, when the correlated sub device exists, the device list management unit 201 may correlate and store information of the corresponding sub device and information of the sensed main device. For example, as shown in FIG. 3A, the device list management unit 201 may allow information (a device ID, a device type, a device name, and a list of operations) of the sub device correlated to the main device to be included in the information on the main device, and store and manage the information. For another example, as shown in FIG. 3B, the device list management unit 201 may separately store information of the main device and information of the sub device correlated to the main device and include only ID information of the sub device correlated to the main device in the information of the main device to store and manage the information. As described above, the device list management unit 201 may include class information for distinguishing the main device and the sub device in the information of the main device and information of the sub device to store and manage the class information. Meanwhile, when the sensed device is the sub device, the device list management unit 201 may identify whether a main device correlated to the sensed sub device exists. Further, when the correlated main device exists, the device list management unit 201 may correlate and store information of the corresponding main device and information of the sensed sub device. When sensing a new device, the device list management unit 201 may identify a correlation between the main device and the sub device through device information received from the sensed device, identify the correlation between the main device and the sub device through a comparison information of the received device and a pre-stored database, or identify a correlation between the main device and the sub device through a user input.

Further, the device list management unit 201 may receive information on a communication scheme (e.g., ZigBee, Wi-Fi, and Bluetooth) which the sensed device can support from a user or receive the information from a device correlated to the sensed device, thereby determining whether the device list management unit can directly communicate with the sensed device. When the device list management unit cannot directly communicate with the sensed device, the device list management unit 201 may generate a device list to transmit a control command through a device which can directly communicate with the electronic device 200 of the sensed device and the wiredly/wirelessly connected device. For example, although a plurality of ZigBee devices supporting only the ZigBee communication scheme have been sensed, when the electronic device 200 does not support the ZigBee communication scheme and supports only a Wi-Fi communication scheme, the device list management unit 201 may correlate and store information of the ZigBee device and information of a specific device so as to control the sensed ZigBee device through the specific device supporting the Wi-Fi communication scheme among other devices wiredly or wirelessly connected to the sensed ZigBee device.

The device operation control unit 203 may analyze a received control command and then control the main device and the sub device. That is, the device operation control unit 203 may receive, from the user equipment, a control command for controlling a main device and a sub device registered in the electronic device 100, identify ID information and operation information of a target device in the received control command, and then control a main device corresponding to the identified ID information of the target device or a sub device correlated to the corresponding main device according to the operation information.

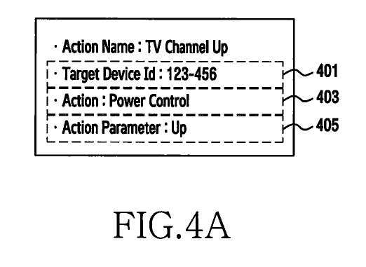

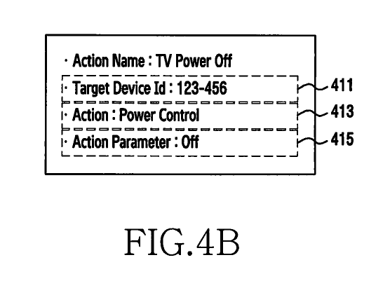

When the operation information identified in the received control command exists in an operation list of the main device, the device operation control unit 203 may transmit the corresponding operation command to the main device in order to control an operation of the main device. For example, as shown in FIG. 4A, when the control command has been received from the user equipment, the device operation control unit 203 may identify that ID information 401 of the target device is “123-456” from the received control command, and identify that operation information 403 is a “Channel Control”. Then, the device operation control unit 203 may identify that the main device corresponding to the “123-456” is a living room TV, and identify whether the “Channel Control” exists in the operation list of the living room TV. The device operation control unit 203 may make a control to identify that a “Channel Control” 301 exists in the operation list of the living room TVs, transmit the operation command including an operation parameter 405 to the living room TV, and change a channel of the living room TV.

Meanwhile, when the operation information identified in the received control command does not exist in the operation list of the main device, the device operation control unit 203 may identify whether the identified operation information exists in the operation list of the sub devices correlated to the corresponding main device, and transmit the corresponding operation command to the sub device in order to control an operation of the sub device when it is identified that the identified operation information exists in the operation list of the sub device. For example, as shown in FIG. 4B, when the control command has been received from the user equipment, the device operation control unit 203 may identify that ID information 411 of the target device is “123-456” from the received control command, and identify that operation information 413 is a “Power Control”. Then, the device operation control unit 203 may identify that the main device corresponding to the “123-456” is a living room TV, and identify whether the “Power Control” exists in the operation list of the living room TV. The device operation control unit 203 may identify that the “Power Control” does not exist in the operation list of the living room TVs, and identify an operation list of smart plug which is the sub device correlated to the living room TV. The device operation control unit 203 may make a control to identify that a “Power Control” 303 exists in the operation list of the smart plug, transmit the control command including an operation parameter 415 to the smart plug correlated to the living room TV, and change a power supply of the sub device. Herein, the device operation control unit 203 may make a control to convert the control command received from the user equipment into a format corresponding to the main device or the sub device to transmit the converted control command.

Although a case in which the information of the main device and the sub device are stored, as shown in FIG. 3A, has been described as an example in the description, even a case in which information of the main device includes only the ID information of the sub device may be applied with the same scheme as shown in FIG. 3B.

When one control command simultaneously exists in the main device and the sub device correlated to the main device, the device operation control unit 203 may determine a priority of processes of the corresponding control command. For example, the device operation control unit 203 may determine the priorities of control commands which simultaneously exist in the main device and the sub device correlated to the main device, so as to first process the control of the main device without performing the control of the sub device. For another example, the device operation control unit 203 may determine the priorities of control commands which simultaneously exist in the main device and the sub device correlated to the main device, so as to first process the control of the sub device without performing the control of the main device. Further, for another example, the device operation control unit 203 may determine the priority to simultaneously control the main device and the sub device correlated to the main device.

The communication unit 205 may connect to at least one user equipment and a home device through a wired/wireless network (e.g., ZigBee, Wi-Fi, and Bluetooth), and perform communication. For example, the communication unit 205 may receive the control command from the user equipment, provide the received control command to the device operation control unit 203, and transmit the control command to the main device or the sub device according to a control of the device operation control unit 203.

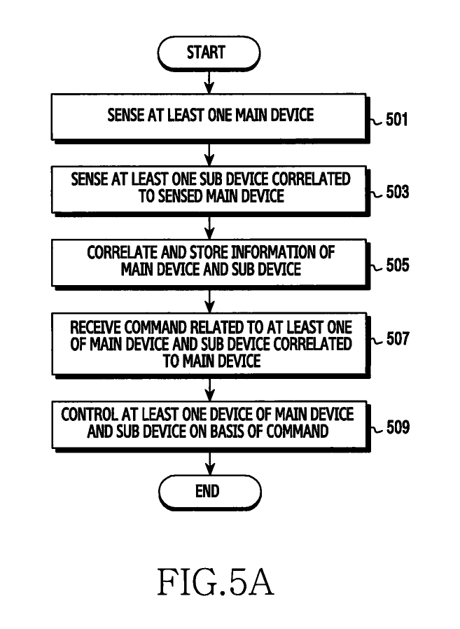

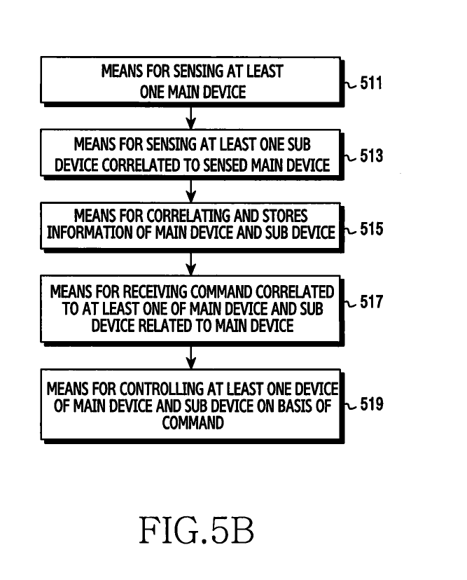

FIG. 5A illustrates a procedure of correlating and controlling the main device and the sub device in the electronic device according to an embodiment of the present invention.

Referring to FIG. 5A, the electronic device 200 may sense at least one main device in step 501. That is, the electronic device 200 may sense at least one device through wired/wireless communication.

Then, the electronic device 200 proceeds to step 503 and may sense at least one sub device correlated to the sensed main device. In this event, the electronic device 200 may identify class information included in information of the sensed device, compare information of the sensed device and pre-stored database, or determine the sensed device as the main device or the sub device according to a user control.

Then, the electronic device 200 proceeds to step 505 and may correlate and store information of the main device and information of the sub device. For example, the electronic device 200 may correlate and store a TV which is the main device and a smart plug which is the sub device. Herein, the smart plug refers to a plug device which connects a plug for a power supply and a home appliance (e.g., a TV and a refrigerator), supplies a power to the home appliance, measures power consumption information of the home appliance, transmits the corresponding information to the electronic device 200, receives a power on/off command from the electronic device 200, and performs a corresponding operation.

Then, the electronic device 200 may receive a command correlated to the main device in step 507. In this event, the electronic device 200 may receive a control command from the user equipment such as a smart phone and a tablet PC, and the received control command may include ID information and operation information of a target device.

Then, the electronic device 200 may control at least one device of the main device and the sub device on the basis of the command in step 509. That is, the electronic device 200 may identify the main device corresponding to ID information of the target device included in the received command and control the main device or the sub device depending on whether operation information included in the received command exists in the operation list of the main device or the operation list of the sub device.

FIG. 5B illustrates a means of correlating and controlling the main device and the sub device in the electronic device according to an embodiment of the present invention.

Referring to FIG. 5B, the electronic device 200 may include a means 511 for sensing at least one main device and a means 513 for sensing at least one sub device correlated to the sensed main device. In this event, the electronic device 200 may include a wired/wireless communication module for sensing at least one device.

Further, the electronic device 200 may include a means 515 for correlating and storing information of the main device and the sub device. Herein, the main device refers to a device, which is independently driven, among home appliances such as a TV, an air conditioner, a refrigerator, and a washing machine, and the sub device refers to a device, which does not independently perform a function of the home appliance and supplements a function of the main device by being interworked with another main device, such as a smart plug, a temperature sensor, and an illumination sensor.

Further, the electronic device 200 may include a means 517 for receiving a command correlated to the main device. In this event, the received command may include ID information and operation information of a target device.

Further, the electronic device 200 may include a means 519 for controlling at least one device of the main device and the sub device on the basis of the command. In this event, the electronic device 200 may include a means for identifying the ID information and the operation information of the target device included in the received command. Further, the electronic device 200 may include a means for identifying whether the identified operation information exists in the operation list of the main device and identifying whether the identified operation information exists in the operation list of the sub device.

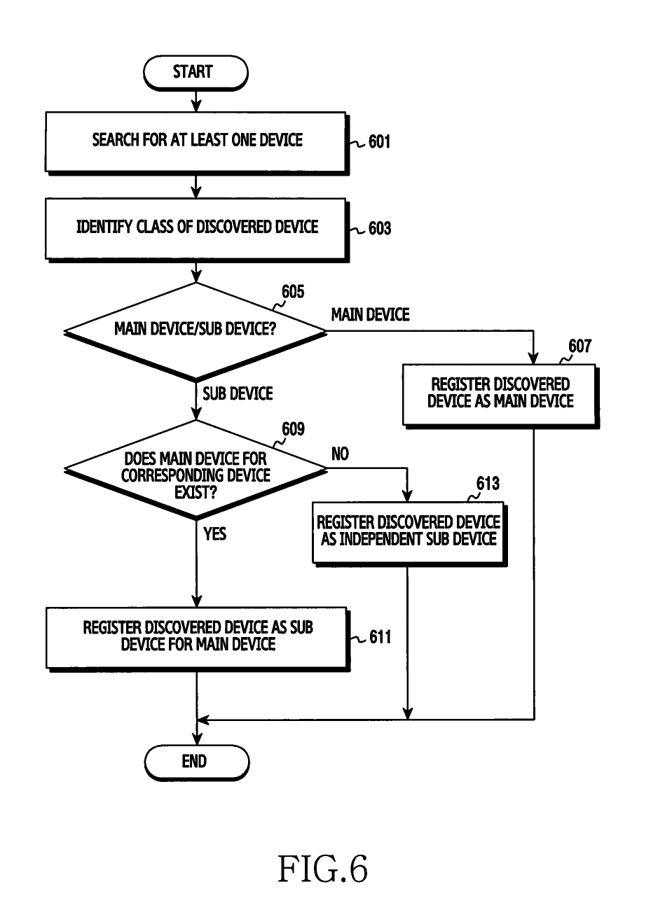

FIG. 6 illustrates a procedure of determining a device sensed in the electronic device as the main device or the sub device according to an embodiment of the present invention.

Referring to FIG. 6, the electronic device 200 may search for at least one device in step 601. That is, the electronic device 200 may search for at least one device through wired/wireless communication.

Then, the electronic device 200 proceeds to step 603 and may identify class information of the discovered device. That is, when a new device has been sensed, the electronic device 200 may identify information of the device, which is received from the sensed device, or class information of the device sensed on the basis of a user input.

Then, the electronic device 200 may identify whether the class information of the discovered device indicates the main device or the sub device in step 605. For example, when at least one device has been discovered through wired/wireless communication, the electronic device 200 may receive device information from the discovered device and identify whether the class information of the sensed device indicates the main device or the sub device. For another example, when the at least one device has been discovered through wired/wireless communication, the electronic device 200 may receive device information from the discovered device and compare the received device information and a pre-stored database to identify whether the class information of the sensed device indicates the main device or the sub device. For another example, when the at least one device has been discovered through wired/wireless communication, the electronic device 200 may receive the class information from the user and identify whether the received class information indicates the main device or the sub device.

When the class information of the discovered device indicates the main device, the electronic device 200 proceeds to step 607, and may register the discovered device as the main device.

Then, the electronic device 200 may terminate a procedure according to an embodiment of the present invention.

Meanwhile, when the class information of the discovered device indicates the sub device, the electronic device 200 proceeds to step 609, and may identify whether the main device for the corresponding device exists. That is, when the discovered device is the sub device, the electronic device 200 may identify whether the main device for the sub device exists. In this event, the electronic device 200 may identify whether the main device for the sub device exists on the basis of device information received from the sub device and the user input.

When the main device for the corresponding sub device exists, the electronic device 200 proceeds to step 611 and may register the corresponding sub device as the sub device for the main device.

Then, the electronic device 200 may terminate a procedure according to an embodiment of the present invention.

Meanwhile, when the main device for the corresponding sub device does not exist, the electronic device 200 proceeds to step 613 and may register the corresponding sub device as an independent sub device.

Then, the electronic device 200 may terminate a procedure according to an embodiment of the present invention.

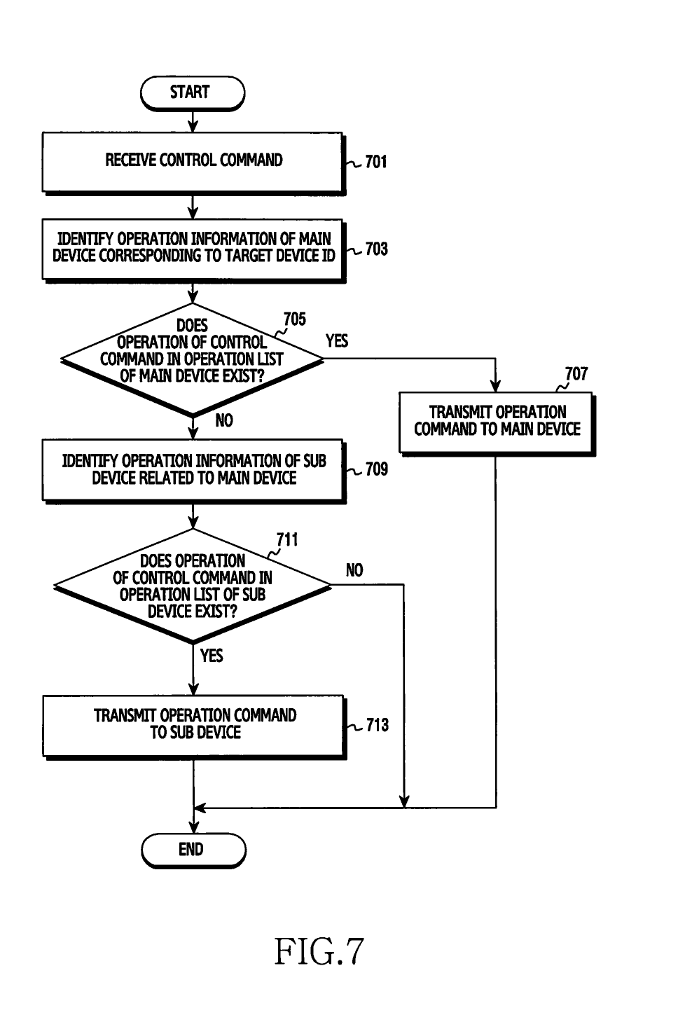

FIG. 7 illustrates a procedure of processing a control command received from the user equipment in the electronic device according to an embodiment of the present invention.

Referring to FIG. 7, the electronic device 200 may receive a control command in step 701. That is, the electronic device 200 may receive the control command from a user equipment.

Then, the electronic device 200 may identify operation information of a main device corresponding to a target device ID. That is, the electronic device 200 may identify ID information and operation information of a target device from the received control command and identify an operation list of the main device corresponding to the ID information of the target device.

Then, the electronic device 200 may identify whether an operation of the control command exists in an operation list of the main device in step 705.

When the operation of the control command exists in the operation list of the main device, the electronic device 200 may transmit the operation command to the main device in step 707. The electronic device 200 may transmit the operation command including the operation parameter to the main device. In this event, the operation parameter may include at least one parameter of channel change information, volume change information, and menu control information.

Then, the electronic device 200 may terminate a procedure according to an embodiment of the present invention.

Meanwhile, when an operation of the control command does not exist in the operation list of the main device, the electronic device 200 proceeds to step 709 and may identify operation information of the sub device correlated to the main device. In detail, the electronic device 200 may identify an operation list of the sub device correlated to the main device corresponding to the ID information of the target device.

Then, the electronic device 200 may identify whether an operation of the control command exists in the operation list of the sub device in step 711.

When the operation of the control command exists in the operation list of the sub device, the electronic device 200 may transmit the operation command to the sub device in step 713. The electronic device 200 may transmit the operation command including the operation parameter to the sub device correlated to the main device. In this event, the operation parameter may include at least one parameter of power on/off information and network change information.

Then, the electronic device 200 may terminate a procedure according to an embodiment of the present invention.

Meanwhile, when the operation of the control command does not exist in the operation list of the sub device, the electronic device 200 may terminate a procedure according to an embodiment of the present invention.

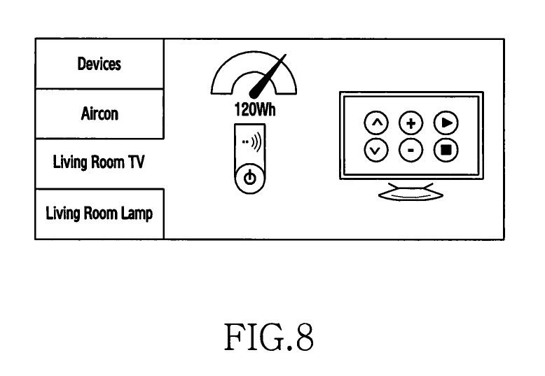

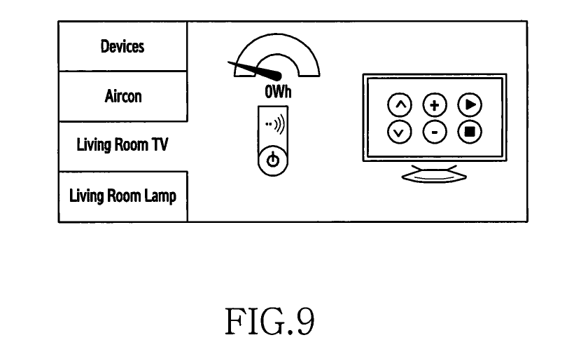

As described above, the electronic device 200, which acts as a smart home gateway, correlates and stores a main device and a sub device. Therefore, a user equipment may obtain information of the sub device correlated to the main device though communication with the electronic device 200 and display both information of the main device and the sub device correlated to the main device, and a control function on a screen when a home device control application is executed to notify a user of a correlation between the main device and the sub device, thereby improving user convenience. For example, as shown in FIG. 8, the user equipment may display main devices in a list of control devices when the home device control application is executed, and display, when a TV which is the main device is to be selected, a state (e.g., a power on/off state, a current channel, and a volume size) and a control function (e.g., channel adjustment, volume adjustment, reproduction, temporary pause, pause, fast forward, and rewind) of the TV, and a state (e.g., power consumption information) and a control function (e.g., a power on/off control) of a smart plug which is a sub device correlated to the TV. Therefore, in order to control a power of a TV, the user may request a power control by selecting a TV device without performing a cumbersome operation of separately searching for the smart plug and performing a TV power control function in the device list. Herein, the user equipment may provide the power consumption information as state information of the smart plug so as to enable the user to recognize the power on/off state of the TV. For example, as shown in FIG. 9, although a power on control function of the smart plug has been requested, when the power of the TV is not turned on due to a fault or malfunction of the TV, the power consumption information of the smart plug may be displayed as “0Wh”. In this event, the user may identify that the power of the TV is substantially turned off on the basis of that the power consumption information of the smart plug is “0Wh”.

Although information of one main device and information of one sub device correlated to the main device have been displayed in FIGS. 8 and 9, when a plurality of sub devices are correlated to the main device, all pieces of information of the plurality of the sub devices may be displayed.

Embodiments and all function operations of the present invention described in the present specification may be implemented by a computer software, firmware, or hardware, which include a structure disclosed in the present specification and an equal structure of these, or a combination of one or more these. Further, embodiments of the present invention described in the present specification may be implemented by a computer program product, i.e., a data processing apparatus, or be implemented by one or more modules of computer program commands on a computer readable medium for controlling an operation of the apparatus.

The computer readable medium may be a machine readable storage medium, a machine readable storage substrate, a memory device, a configuration of materials affecting a machine readable propagation stream, or one or more combinations thereof. The data processing apparatus includes, for example, a programmable processor, a computer, or all nodes, devices, and machines for processing data including a multi-processor or a computer. The nodes may include a code generating an execution environment for a corresponding computer program in addition to hardware, for example, a code configuring a processor firmware, a protocol stack, a database management system, an operation system, or a combination of one or more these.

Although the embodiment has been described in the detailed description of the present invention, the present invention may be modified in various forms without departing from the scope of the present invention. Therefore, the scope of the present invention should not be defined as being limited to the embodiments, but should be defined by the appended claims and equivalents thereof.

1-15. (canceled)

16. A method of a smart home gateway for controlling a smart home system, the method comprising:
sensing at least one main device;
sensing at least one sub device correlated to the at least one main device;
correlating information of the at least one main device and information of the at least one sub device;
storing the correlated information;
receiving a command regarding at least one device of the at least one main device and the at least one sub device; and
controlling the at least one device based on the command.

17. The method of claim 16, wherein sensing the at least one main device comprises:
sensing at least one device indicating that at least one of class information and a device type corresponds to the at least one main device.

18. The method of claim 16, wherein sensing the at least one sub device comprises sensing at least one device indicating that at least one of the class information and the device type corresponds to the at least one sub device, and sensing that information of the correlated device indicates identification information of the sensed device.

19. The method of claim 16, wherein storing the correlated information comprises storing information of the at least one sub device as lower information of the information of the main device.

20. The method of claim 16, wherein storing the correlated information comprises storing information of the at least one sub device independently of the information of the at least one main device and storing ID information of the at least one sub device by including the ID information in the information of the main device.

21. The method of claim 16, wherein the command includes at least one of a name of the at least one main device, an ID of the at least one main device, a type of the at least one main device, operation information, and an operation parameter.

22. The method of claim 21, wherein controlling the at least one device comprises:
determining a main device corresponding to the command as at least one of the name of the main device, the ID of the main device, and the type of the main device which are included in the command;
deciding whether operation information included in the command coincides with the operation information of the main device; and
if the operation information included in the command coincides with the operation information of the main device, requesting, to the main device, to perform a function corresponding to the operation parameter.

23. The method of claim 21, wherein controlling the at least one device comprises:
determining a main device corresponding to the command by at least one of the name of the main device, the ID of the main device, and the type of the main device which are included in the command;
deciding whether operation information included in the command coincides with the operation information of the main device;
if the operation information included in the command does not coincide with the operation information of the main device, deciding whether the operation information included in the command coincides with operation information of the at least one sub device; and
if the operation information included in the command coincides with the operation information of the at least one sub device, requesting, to the at least one sub device, to perform a function corresponding to the operation parameter.

24. The method of claim 16, wherein the at least one main device or the at least one sub device is sensed using at least one communication module of a wired communication module or a wireless communication module.

25. A smart home gateway apparatus for controlling a smart home system, the apparatus comprising:
a controller configured to:
sense at least one main device, sense at least one sub device correlated to the at least one main device, correlate information of the at least one main device and the at least one sub device, store the correlated information, receive a command regarding at least one device of the at least one main device and the at least one sub device, and control the at least one device of the main device and the sub device based on the command.

26. The apparatus of claim 25, wherein the controller is further configured to sense at least one device indicating that at least one of class information and a device type corresponds to the at least one main device.

27. The apparatus of claim 25, wherein the controller is further configured to sense at least one device indicating that at least one of the class information and the device type corresponds to the at least one sub device, and sensing that information of the correlated device indicates identification information of the sensed device.

28. The apparatus of claim 25, wherein the controller is further configured to store information of the at least one sub device as lower information of the information of the main device.

29. The apparatus of claim 25, wherein the controller is further configured to:
store information of the at least one sub device independently of the information of the at least one main device; and
store ID information of the at least one sub device by including the ID information in the information of the main device.

30. The apparatus of claim 25, wherein the command includes at least one of a name of the at least one main device, an ID of the at least one main device, a type of the at least one main device, operation information, and an operation parameter.

31. The apparatus of claim 30, wherein the controller is further configured to:
determine a main device corresponding to the command as at least one of the name of the main device, the ID of the main device, and the type of the main device which are included in the command;
decide whether operation information included in the command coincides with the operation information of the main device; and
if the operation information included in the command coincides with the operation information of the main device, requesting, to the main device, to perform a function corresponding to the operation parameter.

32. The apparatus of claim 30, wherein the controller is further configured to:
determine a main device corresponding to the command by at least one of the name of the main device, the ID of the main device, and the type of the main device which are included in the command;
decide whether operation information included in the command coincides with the operation information of the main device;
if the operation information included in the command does not coincide with the operation information of the main device, deciding whether the operation information included in the command coincides with operation information of the at least one sub device; and
if the operation information included in the command coincides with the operation information of the at least one sub device, requesting, to the at least one sub device, to perform a function corresponding to the operation parameter.

33. The apparatus of claim 25, wherein the at least one main device or the at least one sub device is sensed using at least one communication module of a wired communication module or a wireless communication module.

34. A user equipment (UE) for controlling a smart home system, the user equipment comprising:
a display configured to, if an application for controlling at least one device is executed, display a device list indicating at least one main device registered in an electronic device acting as a home gateway, and display information of the at least one main device in the device list and information of at least one sub device correlated to the at least one main device.

35. The UE of claim 34, further comprising:
a transceiver configured to transmit a command regarding at least one device of the at least one main device and the at least one sub device,
wherein the command includes at least one of a name of the at least one main device, an ID of the at least one main device, a type of the at least one main device, operation information, and an operation parameter.
